(19) United States
(12) Patent Application Publication
(10) Pub. No.: US 2026/0222832 A1
(43) Pub. Date: Jul. 30, 2026

(54) TECHNIQUES FOR PHYSICAL LAYER OPTIMIZATIONS IN FEDERATED LEARNING

(71) Applicant: QUALCOMM Incorporated, San Diego, CA (US)

(72) Inventors: Amit MOSES, Tel Aviv (IL); Gideon Shlomo KUTZ, Ramat Hasharon (IL); Ronen SHAKED, Kfar Saba (IL)

(21) Appl. No.: 19/039,695

(22) Filed: Jan. 28, 2025

(51) Int. Cl. H04W 24/02; G06N 20/00; H04L 5/00

(52) U.S. Cl. CPC H04W 24/02; G06N 20/00; H04L 5/0051

(57) ABSTRACT

Certain aspects of the present disclosure provide techniques for wireless communications. An example method includes transmitting, to a set of nodes, first information associated with a first model parameter and a first gradient step value, the first information being associated with federated learning at the set of nodes; receiving, from the set of nodes, one or more first gradient indications for the first model parameter; and transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.

### INTRODUCTION

### Field of the Disclosure

Aspects of the present disclosure relate to wireless communications, and more particularly, to techniques for physical layer configurations (e.g., optimizations) in federated learning.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a network entity. The method includes transmitting, to a set of nodes, first information associated with a first model parameter and a first gradient step value, the first information being associated with federated learning at the set of nodes; receiving, from the set of nodes, one or more first gradient indications for the first model parameter, wherein the one or more first gradient indications are received on a first set of receive antennas; and transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.

Certain aspects provide a method for wireless communications by a user equipment (UE). The method includes receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications; receiving, from the network entity, first information associated with a first model parameter and a first gradient step value, the first information being associated with the federated learning; and transmitting, to the network entity, a first gradient indication for the first model parameter using the amplitude pre-equalization.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a diagram of an example environment associated with federated learning.

FIG. 6 depicts an example resource configuration for gradient signaling.

FIG. 7 depicts an example of signaling relating to non-coherent over the air (OTA) computation using multiple receive antennas.

FIG. 8 depicts an example of signaling relating to artificial intelligence (AI) pilot transmission.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for physical layer configurations (e.g., optimizations) in federated learning.

The 5G New Radio (NR) physical layer is a component of the Third Generation Partnership Project (3GPP) 5G wireless communication standard and the advanced services thereof. The 5G NR physical layer is designed to support various over the air (OTA) use cases across a wide range of frequencies and deployment scenarios. The 5G NR physical layer uses orthogonal frequency division multiplexing (OFDM) as the core waveform, and wireless transmissions in the 5G NR physical layer often use coherent transmission techniques, which rely on precise channel state information at the receiver side of the wireless transmission. These coherent transmission techniques require near perfect uplink (UL)/downlink (DL) channel reciprocity.

As network architectures evolve to the 3GPP 6G wireless communication standard and beyond, decentralized and artificial intelligence/machine learning (AI/ML) training is expected to be incorporated into these network architectures. Federated learning is a machine learning technique that trains an AI model across multiple decentralized edge nodes. Each of the edge nodes may perform local model training using local data samples. Thus, federated learning enables training AI models on distributed datasets without centralizing the data. Federated learning addresses privacy concerns (e.g., raw data never leaves a node) while allowing for collaborative model development across multiple nodes in a network.

The AI model, and communications associated therewith, may be delivered via an over-the-air (OTA) interface. For example, transmissions associated with parameters of an AI model structure known at the receiving end and/or new AI models with new parameters may be delivered via the OTA interface of the multiple decentralized edge nodes. These OTA transmission can vary in bandwidth and duration, for example, depending on whether full AI models or partial AI models are being transmitted. For high mobility environments and various scenarios where near perfect uplink and downlink (UL/DL) channel reciprocity may not exist, coherent transmission techniques are not practical for OTA transmissions between the multiple decentralized edge nodes for federated learning.

Aspects described herein provide non-coherent transmission techniques to improve performance of (e.g., optimize) the physical layer for training AI models in federated learning. Non-coherent transmission techniques or schemes involve encoding information in the energy levels of signals rather than in precise phase relationships. A non-coherent transmission scheme enables the multiple decentralized edge nodes to transmit simultaneously without coordination of the OTA transmissions. Non-coherent OTA transmissions are integrated into the orthogonal frequency division multiplexing (OFDM) framework. For example, information may be encoded into the energy levels or specific subcarriers of an OFDM symbol.

In some aspects, a node may determine a voting reliability using a non-coherent transmission scheme, for example, by receiving a gradient indication from a plurality of nodes using a plurality of receive antennas and comparing a determined vote on each of the plurality of receive antennas to determine a likelihood of the vote being correct (referred to as a voting reliability). When the voting reliability is determined to be high, a gradient step size of an AI model may be scaled up. When, the voting reliability is determined to be low, a gradient step size of an AI model may be scaled down. In some examples, an amplitude pre-equalization and reference signal pilot structure is provided to improve non-coherent OTA transmissions for non-coherent OTA transmissions.

The techniques for non-coherent transmission techniques to improve performance of the physical layer for training AI models in federated learning as described herein may provide various enhancements and/or improvements. The techniques for non-coherent transmission techniques to improve performance of the physical layer for training AI models in federated learning may reduce the time to converge on a particular AI model parameter, for example, by varying the gradient step size in accordance with a voting reliability. The techniques for non-coherent transmission techniques to improve performance of the physical layer for training AI models in federated learning may reduce signaling overhead time to converge on the particular AI model parameter, for example, by spending less time and reference signal resources on channel estimation using non-coherent OTA transmissions and amplitude-based reference signals.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

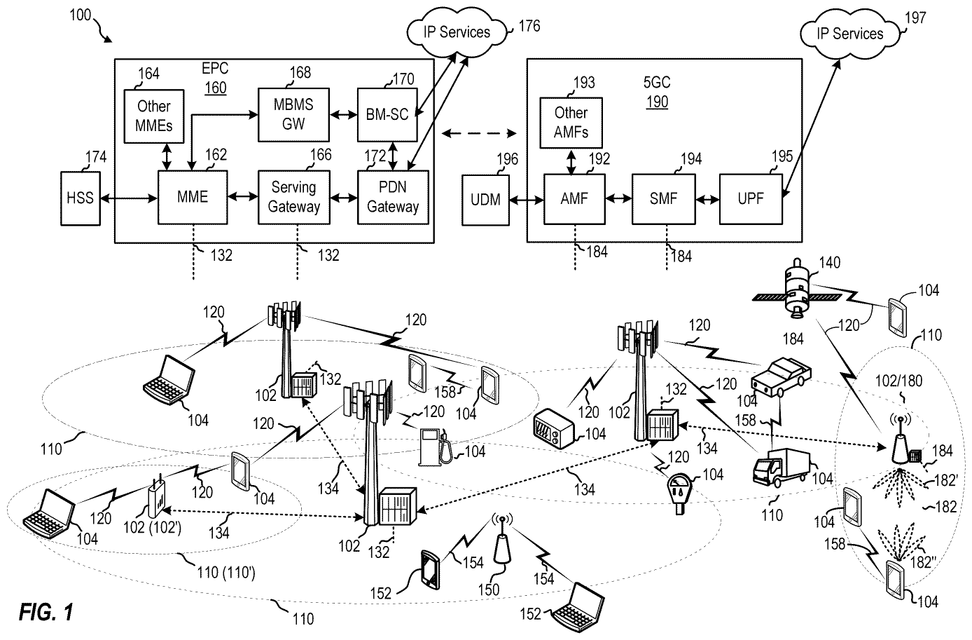

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

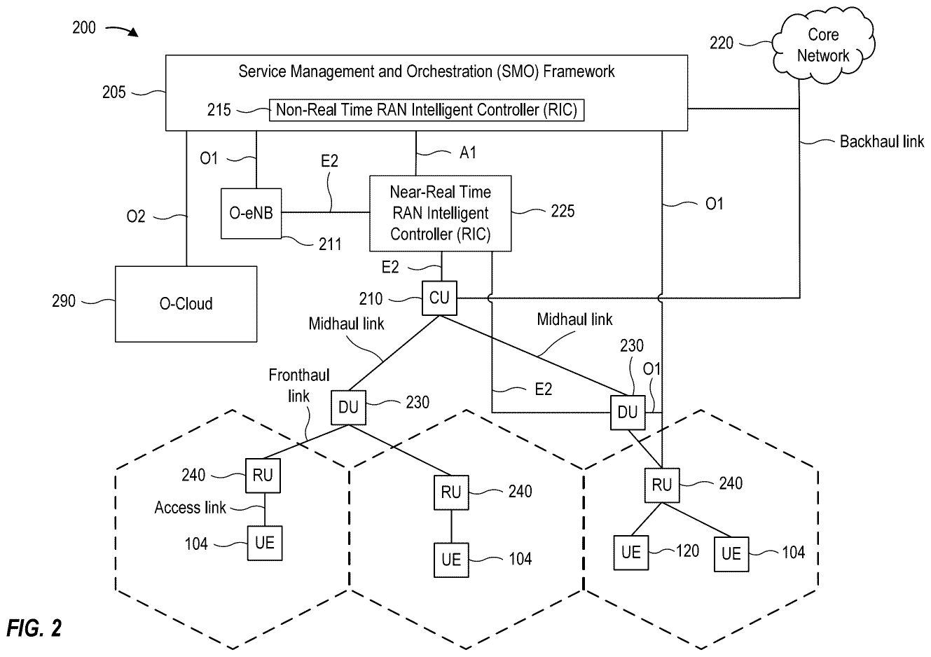

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

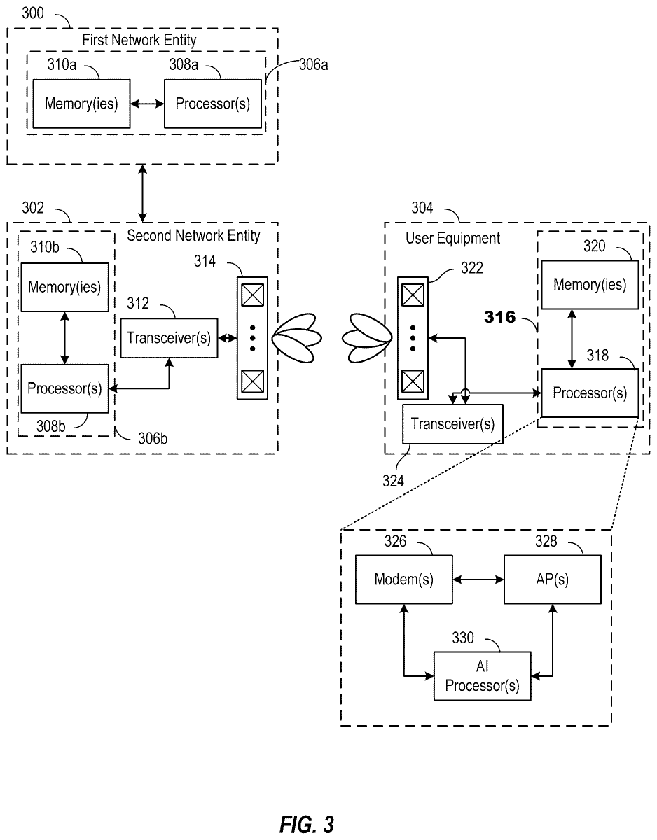

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

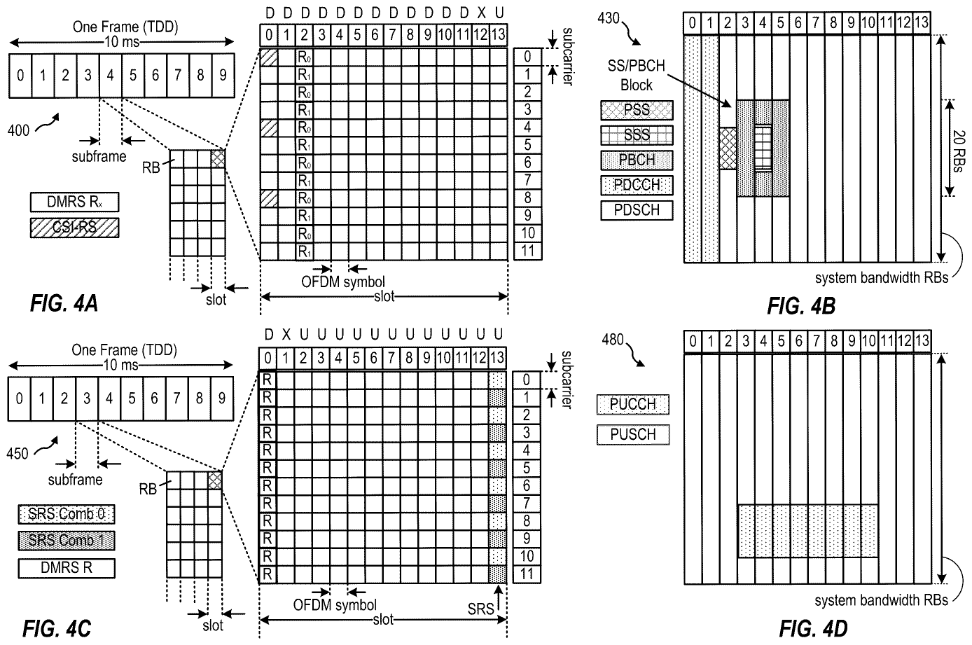

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

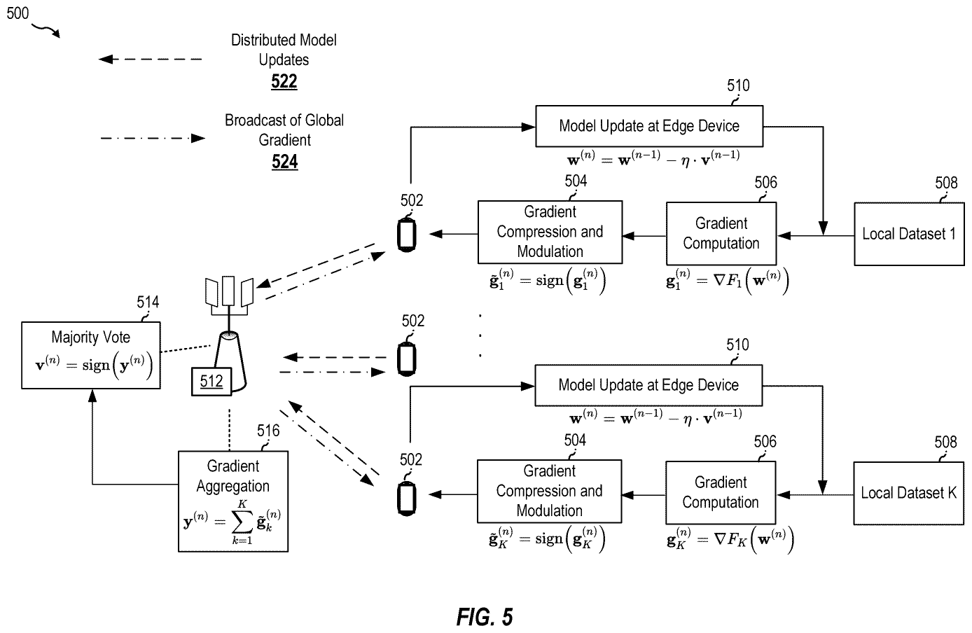

FIG. 5 is a diagram of an example environment 500 associated with federated learning according to one or more aspects. The parameter server 512 (also referred to as an edge server) may correspond to the BS 102, the first network entity 300, the second network entity 302, or an element of a disaggregated RAN described with regard to FIG. 2. The edge device 502 may correspond to the UE 104 or 304. An edge device 502 may be referred to herein as a node, and a parameter server 512 may be referred to herein as a network entity.

Federated learning is a technique that may enable users (e.g., UEs or edge devices) to train a ML model (e.g., a neural network) in a collaborative and distributed fashion using users' local datasets at edge devices (e.g., nodes). Specifically, in each round, the parameter server 512 may select a number of edge devices 502, and may transmit 524 a copy of the global ML model (e.g., the copy may include the parameters (weights) or a gradient set of the global ML model) to each of the selected edge devices 502. Then, at 506, each edge device 502 may compute updated local model parameters or gradients (or gradient set elements) of the ML model based on a local copy of the ML model (which may be referred to as the local ML model hereinafter) that is updated, at 510, with the local dataset 508 at the edge device 502. At 504, each edge device 502 may compress and/or modulate the computed local gradients (or gradient set elements) in preparation for transmission. Next, each edge device 502 may feedback, at 522, the corresponding update including the updated local model parameters or the local gradient set elements to the parameter server 512. Thereafter, the parameter server 512 may aggregate, at 516, all the updates 522 from the edge devices 502, and may update, at 514, the global ML model based on the aggregated updates and a majority vote. For the next iteration/round, the parameter server 512 may transmit a copy of the updated global machine model (e.g., parameters (weights) or a global gradient set) to selected edge devices 502, and the edge devices 502 may perform again similar operations as described above. The process may be repeated for a number of times corresponding to a number of iterations/rounds until the global ML model converges (e.g., until the global model update may no longer produce any non-negligible changes to the global ML model).

Federated learning may be associated with the advantage of keeping user data (e.g., local dataset 508) private at edge devices 502 based on the distributed optimization framework (i.e., the user data itself may not be transmitted to the parameter server 512).

In one or more configurations, the federated learning, in particular, the gradient update and aggregation, may be performed using a “signSGD” approach. For the federated learning, in communication round n, the k-th UE may calculate the gradient,

$${w}_{k}^{( n )} ,$$

based on a subset of the local dataset of the k-th UE, and may send the gradient to the network (e.g., the parameter server). For the OTA federated learning, multiple nodes may share the same resources for transmitting their gradients. In particular, each UE may transmit

$$\frac{{w}_{k}^{( n )}}{{h}_{k}^{( n )}} ,$$

where

$${h}_{k}^{( n )}$$

may be the channel coefficient of the resource (referred to as channel pre-compensation). Of course, there may be different schemes for the channel pre-compensation at the UE (e.g., zero forcing, minimum mean square error (MMSE), etc.).

In one or more configurations, the received signal at the parameter server at the n-th communication round may be given as follows:

$${r}^{( n )} = {\sum }_{k = 1}^{K} {h}_{k}^{( n )} \frac{{w}_{k}^{( n )}}{{h}_{k}^{( n )}} = {\sum }_{k = 1}^{K} {w}_{k}^{( n )} .$$

For the OTA federated learning, gradient combining may be performed OTA utilizing the superposition property of the wireless channel. Due to the channel pre-compensation, the gradients may be coherently combined. The network (e.g., the parameter server) may be interested just in the sum of the local gradients. Hence, there may be no need to resolve the interference between the gradients transmitted by the different nodes. In fact, the interference may be utilized to accumulate the gradients.

In one or more configurations, instead of sending the actual gradients, the nodes may implement the “signSGD” approach. In particular, with the “signSGD” approach, a node may send just the sign of the gradient instead of the actual gradient. The “signSGD” approach may be associated with efficient compression of the gradient transmission. Accordingly, use of the “signSGD” approach may lead to reduction of transmission overhead while maintaining a high convergence rate.

Accordingly, in one or more configurations, the gradient combining for the federated learning may be performed in a non-coherent fashion. In particular, all UEs may simultaneously transmit the signs of respective gradients using a non-coherent orthogonal modulation scheme using two resources: l⁺ and l⁻. The transmitted symbols t_{k,l}_{⁺} and t_{k,l}_{^{−}} may be given as follows:

$${t}_{k , {l}^{+}} = \{ \begin{matrix}\sqrt{{p}_{k}} \times {s}_{k , i}^{( n )} , & when {w}_{k , i}^{( n )} \geq 0 \\ 0 , & when {w}_{k , i}^{( n )} < 0\end{matrix} ,$$

$${t}_{k , {l}^{-}} = \{ \begin{matrix}0 , & when {w}_{k , i}^{( n )} \geq 0 \\ \sqrt{{p}_{k}} \times {s}_{k , i}^{( n )} , & when {w}_{k , i}^{( n )} < 0\end{matrix} ,$$

where

$${s}_{k , i}^{( n )}$$

may be a (pseudo-)random symbol on a unit circle, and may be independent (different) across resources and UEs, pₖ may be the power of the transmitted symbol, i may represent the gradient index, and l may represent the time-frequency resource index.

Accordingly, at the network (e.g., the parameter server), the received superimposed (superposed) compressed gradients on the pair of resources may be given as follows:

$${r}_{{l}^{+}}^{( n )} = {\sum }_{∀ k} \sqrt{{p}_{k}} {h}_{k , {l}^{+}}^{( n )} {s}_{k , i}^{( n )} + {n}_{{l}^{+}}^{( n )} ,$$

$${r}_{{l}^{-}}^{( n )} = {\sum }_{∀ k} \sqrt{{p}_{k}} {h}_{k , {l}^{-}}^{( n )} {s}_{k , i}^{( n )} + {n}_{{l}^{-}}^{( n )} .$$

In some configurations, the channel phase may be random. Further, it may be assumed that the UEs may not have the channel phase information to perform channel pre-compensation.

In one or more configurations, the received power on both resources l⁺ and l⁻ may be accumulated. The average power of the received signals on the two resources may be given as follows:

$$E [ {r}_{{l}^{+}}^{( n )} {r}_{{l}^{+}}^{{( n )}^{*}} ] = {\sum }_{∀ {k}_{∈ {K}^{+ ( n )}}} {p}_{k} + {σ}^{2} ,$$

$$E [ {r}_{{l}^{-}}^{( n )} {r}_{{l}^{-}}^{{( n )}^{*}} ] = {\sum }_{∀ {k}_{∈ {K}^{- ( n )}}} {p}_{k} + {σ}^{2}$$

where K⁺^{⁽ⁿ⁾} and K⁻^{⁽ⁿ⁾} may be the set (list) of UEs voting for positive and negative gradients, respectively, in the n-th communication round, and σ² may be the noise power. The small scale fading channel coefficients

$${h}_{k , {l}^{+}}^{( n )} and {h}_{k , {l}^{-}}^{( n )}$$

may be averaged out, since

$$E \{ \vert {h}_{k , {l}^{+}}^{( n )} {\vert}^{2} \} = E \{ \vert {h}_{k , {l}^{-}}^{( n )} {\vert}^{2} \} = 1.$$

In one or more configurations, the same gradient may be transmitted over multiple resources to achieve sufficient channel averaging. The majority vote may then be given as follows:

$${v}_{i}^{( n )} = sign ( {\vert {r}_{{l}^{+}}^{( n )} \vert}_{2}^{2} - {\vert {r}_{{l}^{-}}^{( n )} \vert}_{2}^{2} ) .$$

Next, the majority vote may be used to update the global training parameters. Thereafter, the parameter server may share the updated global training parameters (e.g., weights) with the UEs.

In one or more configurations, the network (e.g., the parameter server) may be configured to enable the non-coherent combining of the local gradients without channel pre-compensation. To that end, the network may configure UEs participating in the federated learning (training) to send the local gradient updates (which may be referred to simply as gradients) using a non-coherent orthogonal modulation scheme. An example non-coherent orthogonal modulation schemes have been described in detail above. In particular, the network may configure the UEs to transmit indications of the signs of the local gradients using the “signSGD” approach, instead of sending the actual gradients. In one or more configurations, the network may configure the UEs with the non-coherent orthogonal modulation scheme via one or more of an RRC message, a MAC control element (MAC-CE), a system information (SI) message, or a DCI message.

As part of a federated learning process for an ML model, such as an artificial neural network, parameters affecting the functioning of artificial neurons and layers of the ML model may be adjusted. For example, backpropagation techniques may be used to train the ML model by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

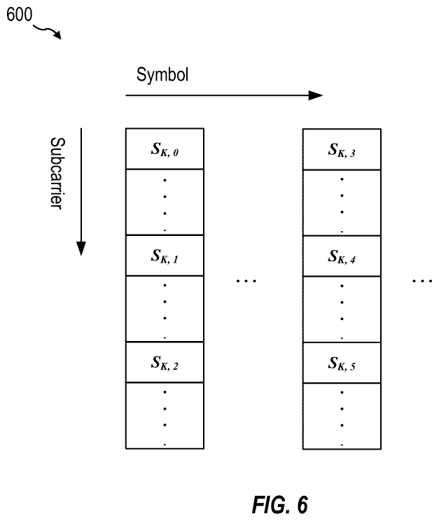

FIG. 6 is a diagram 600 illustrating an example resource configuration for gradient signaling. In one or more configurations, the network (e.g., the parameter server) may configure the resources that the nodes may use to transmit gradient updates using the non-coherent orthogonal modulation scheme. As shown in FIG. 6, the resource configuration for the non-coherent orthogonal modulation scheme may include one or more of a time (e.g., slots, symbols) configuration, a frequency (e.g., RBs, REs in an RB) configuration, and/or a beam (e.g., a quasi co-location (QCL) relationship) configuration.

Unlike for pulse-amplitude modulation (PAM) or quadrature amplitude modulation (QAM), for the non-coherent orthogonal modulation scheme, the network (e.g., the parameter server) may configure a pair of resources (e.g., l⁺ and l⁻) for the gradient transmissions from the nodes. The network may then compare the received signals (e.g., received power) on the pair of resources to decode the majority vote of all participating nodes. In one or more further configurations, the network may configure multiple resources for the same gradient transmission (i.e., multiple resources for indications of positive/non-negative gradients and/or multiple resources for indications of negative/non-positive gradients) to achieve sufficient channel averaging.

In one or more configurations, the network (e.g., the parameter server) may configure the resources for the gradient transmissions from nodes taking into consideration fairness between the pair of resources associated with the non-coherent orthogonal modulation scheme. As described above, each symbol in the non-coherent orthogonal modulation scheme may be transmitted by one or more UEs using a pair of resources. It may be desired to achieve fairness between the received power in the pair of resources associated with the non-coherent orthogonal modulation scheme. In one or more configurations, for each node, the pair of resources may be configured with the same QCL properties to achieve fairness between the received power levels on these resources. That is, the node may not receive different QCL properties or different power configurations for the pair of resources associated with the non-coherent orthogonal modulation scheme. In one or more configurations, the pair of resources associated with the non-coherent orthogonal modulation scheme may be configured on the same component carrier (CC) and/or the same BWP to achieve fair comparison between the received power levels in the pair of resources. For example, the l⁺ and l⁻ resources may be on different REs on the same RB, or may be adjacent (or nearby) symbols. In general, the pair of resources associated with the non-coherent orthogonal modulation scheme may be located on nearby REs on the time-frequency grid so that the pair of resources may be associated with similar channel properties.

In one or more configurations, the network (e.g., the parameter server) may configure the resource mapping (e.g., parameters associated with resource mapping) in the non-coherent modulation scheme. Each node participating in the federated learning may send one or more gradients (or a compressed version of the gradients, e.g., using the “signSGD” approach) to the network. A mapping may be defined between the gradients and the resources. For example, the mapping may start with gradients of the inner (or outer) layers of the neural network, and then may move to the outer (or inner) layers. In such an order, the gradients may be mapped one by one to the resources in the time frequency grid. As such, the gradients may be mapped to the configured resources. For another example, for each gradient, the mapping may start with the l⁺ (or l⁻) resource first, and then may be followed by the l⁻ (or l⁺) resource. In some configurations, l⁺ may be mapped to the even-indexed resources and l⁻ may be mapped to the odd-indexed resources. In some other configurations, l⁺ may be mapped to the odd-indexed resources and l⁻ may be mapped to the even-indexed resources. In one or more configurations, the network (e.g., the parameter server) may adjust/change the resource mapping configuration (e.g., resource mapping parameters) using one or more of an RRC message, a MAC-CE, an SI message, or a DCI message.

### Aspects Related to Physical Layer Configurations (e.g., Optimizations) in Federated Learning

In a basic non-coherent transmission scheme, a network element may make an erroneous decision. For example, even if a majority of the UE decided on ‘1’ as the gradient value, scenarios may arise where these signals representing the gradient value of ‘1’ are added destructively. Additionally, or alternatively, a minority of the UE may decide on ‘0’ as the gradient value and may send signals representing the gradient value of ‘0’. These signals representing the gradient value of ‘0’ may add constructively, thereby resulting in higher energy for the cumulative gradient value of ‘0’.

In some aspects, a sufficiently large number of receive antennas may be used at the network element. The sufficiently large number of receive antennas may aid in achieving a soft majority vote, thereby yielding a target low erroneous decision probability. By operating the federated AI/ML learning at a low erroneous decision probability, convergence may be accelerated.

In some aspects, the power of the signal from all nodes may be assumed to be equal. For example, the phase of the signal may be random (e.g., the phase is unknown for each signal from each node). The receive value, y_{0,r}, for the signals representing the gradient value of ‘0’ in each antenna is a normal distribution with a variance of M₀σ² and can be represented as follows: y_{0,r}~N(0, M₀σ²), where M₀ is the number of nodes sending signals representing the gradient value of ‘0’.

Similarly, the receive value, y_{1,r}, for the signals representing the gradient value of ‘1’ in each antenna is a normal distribution with a variance of M₁σ² and can be represented as follows: y_{1,r}~N(0, M₁σ²), where M₁ is the number of nodes sending signals representing the gradient value of ‘1’.

For example, in a first receive antenna, a first resource element associated with y_{0,r} corresponds to all of the signals representing the gradient value of ‘0’ from all of the nodes that decided on ‘0’ as the gradient value (e.g., a negative gradient value). The network element may obtain the sample, y_{0,r}, from the distribution N(0, M₀σ²).

Additionally, in the first receive antenna, a second resource element associated with y_{1,r} corresponds to all of the signals representing the gradient value of ‘1’ from all of the nodes that decided on ‘1’ as the gradient value (e.g., a positive gradient value). The network element may obtain the sample, y_{1,r}, from the distribution N (0, M₁σ²).

The energy in each receive antenna in the set of receive antennas may be calculated. Then, the sum of all of the energies from each receive antenna in the set of receive antennas may be calculated over all of the corresponding resource elements.

For example, a first energy sum of the energies for the set of receive antennas and all of resource element representing the gradient value of ‘0’ from all of the nodes that decided on ‘0’ as the gradient value (e.g., a negative gradient value) may be defined as z₀. Similarly, a second energy sum of the energies for the set of receive antennas and all of resource element representing the gradient value of ‘1’ from all of the nodes that decided on ‘1’ as the gradient value (e.g., a positive gradient value) may be defined as z₁. The first and second energy sums may be defined as follows:

$${z}_{0} = {\sum }_{r = 0}^{R - 1} {\vert {y}_{0 , r} \vert}^{2} , {z}_{1} = {\sum }_{r = 0}^{R - 1} {\vert {y}_{1 , r} \vert}^{2} , then {z}_{0} = {M}_{0} {σ}^{2} {P}_{0} and {z}_{1} = {M}_{1} {σ}^{2} {P}_{1} ,$$

$$where {P}_{0} , {P}_{1} ∼ {χ}^{2} ( 2 R )$$

For example, z₀ may be defined as multiple, M₀, sigma squared, σ², where the sigma squared, σ² is the variance associated with the resource element representing the gradient value of ‘0’ (e.g., a negative gradient value having a transmission of −1). The multiple, M₀, sigma squared, σ², is multiplied by P₀, where by P₀, is the distribution Chi-square, χ₂, with a degree of twice the receive antenna (2R) (e.g., a Chi-square distribution with 2R degrees of freedom).

From z₀ and z₁, it can be seen that utilizing more receive antennas may be desirable because the additional receive antennas allow the the energies to be combined. After combining the energies, the network entity may decide whether z₀>z₁ or z₁>z₀. If the network entity decides on the gradient value of ‘1’ if z₁>z₀ and the gradient value of ‘0’, otherwise.

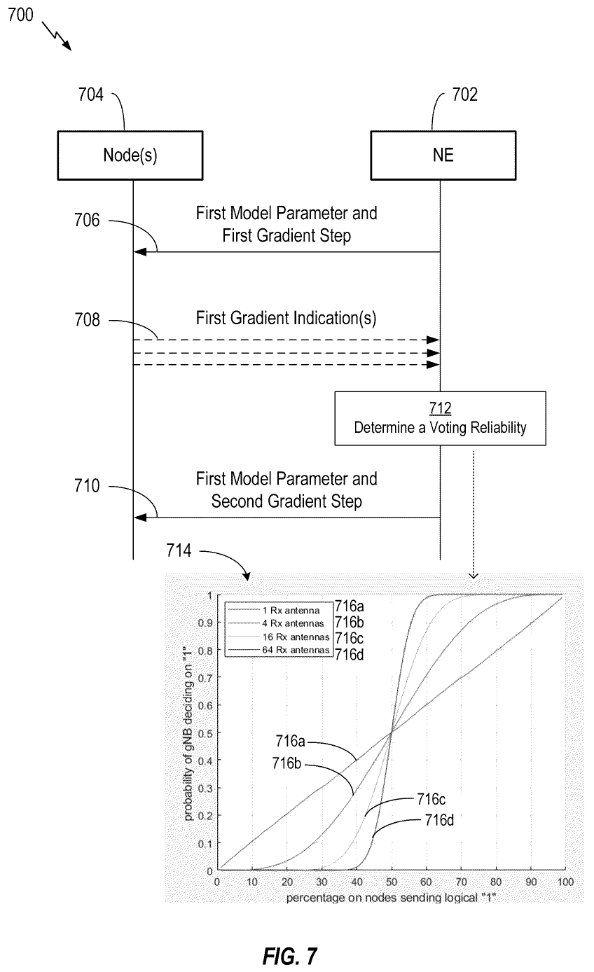

For a larger set of receive antennas, the reliability of each decision is greater than for a smaller set of receive antennas. The number of receive antennas in the set of receive antennas that is sufficiently large to achieve a threshold reliability may be based on the requirements of a particular AI model. Simulation results (e.g., as shown in voting reliability chart 714 in FIG. 7) demonstrate this reliability property. That is, for example, by guaranteeing the required number of receive antennas are used, the shape of the probability function at the network entity can be controlled. Therefore, any desired target erroneous decision probability can be achieved, in accordance with some aspects. In this manner, the accelerated convergence of a particular AI model can be optimized. For example, if the target the particular AI model is complex, a larger number of antennas is more desirable to accelerate convergence.

In some aspects, the number of antennas used during training may be dynamic. For example, if a larger error during a first portion or task of a training process (e.g., during a beginning portion of the training process) can be tolerated for the particular AI model, then a lower number for the set of receive antennas may be used during the first portion or task of the training process. Conversely, if a smaller error during a second portion or task of the training process (e.g., during a later portion of the training process) is preferred for the particular AI model, then a higher number for the set of receive antennas may be used during the second portion or task of the training process.

That is, for example, different numbers of receive antennas corresponding to the different probability shapes may be used within the same AI model for different model parameters. Similarly, the numbers of receive antennas corresponding to the different probability shapes may be modified per iteration of an AI model should the target erroneous probability error desired be modified in each iteration.

In some examples, the network element may configure a large number of antennas, along with a first time and frequency resource (e.g., one or more first resource elements) and a second time and frequency resource (e.g., one or more second resource elements). In some examples, the first time and frequency resource and the second time and frequency resource number may be associated with time and frequency resources that may be allocated in FR2 and or FR3.

The first time and frequency resource may be configured to receive all of the signals representing the gradient value of ‘0’ from all of the nodes that decided on ‘0’ as the gradient value, and the second time and frequency resource may be configured to receive all of the signals representing the gradient value of ‘1’ from all of the nodes that decided on ‘1’ as the gradient value. The network element may configure a large number of antennas and a first resource element to receive all of the signals representing the gradient value of ‘0’ from all of the nodes that decided on ‘0’ as the gradient value.

The network element may sample each receive antenna separately, and evaluate whether a received signal represents the gradient value of ‘0’ or the gradient value of ‘1’ for each receive antenna of the large set of receive antennas. That is, for example, the gradient value of ‘0’ vs. ‘1’ hypothesis for each receive antenna separately (and simultaneously) before calculating the first energy sum, z₀ and the second energy sum z₁. This gradient value of ‘0’ vs. ‘1’ hypothesis each receive antenna separately may converge to an expected percentage of the gradient value of ‘0’ vs. the gradient value of ‘1’ (e.g., as shown in plot 716a of the voting reliability chart 714 in FIG. 7).

The network element may have an initial expected percentage of the nodes that are expected to decide on ‘0’ as the gradient value and the nodes that are expected to decide on ‘1’ as the gradient value. From this initial expected percentage, the network entity can deduce the probability of correctly deciding whether a particular node sent a ‘1’ as the gradient value. Based on the probability of correctly deciding whether a particular node sent a ‘1’ as the gradient value, the network entity can scale the gradient step value accordingly.

First, the network entity may determine what is the decision between “0′ or ‘1’ as the gradient value. Second, the network entity may determine what is the reliability associated with the decision of the ‘0’ or ‘1’ as the gradient value.

For example, if 80% of the nodes sent a ‘1’ as the gradient value, the voting reliability can be considered as high, and the gradient step size can be scaled up. If, however, 55% of the nodes sent a ‘1’ as the gradient value, the voting reliability can be considered as low, and the gradient step size can be scaled down.

In some examples, a zero force of a gradient decision may be performed because reliable information is not available with respect to transmissions on the UL channel. For example, the closer the decision between “0′ or ‘1’ as the gradient value is to 50%, then the probability of error is large. In some examples, the probability can also change based on the number of antennas in the set of antennas.

FIG. 7 depicts an example 700 of signaling relating to non-coherent over the air (OTA) computation using multiple receive antennas. Example 700 shows signaling communications in a network between a network entity 702 and a set of nodes 704 (e.g., UEs). In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Additionally, or alternatively, the network entity 702 may be an example of a parameter server 512. Similarly, the node 704 may be an example of UE 104 depicted and described with respect to FIG. 1 or the UE 304 depicted and described with respect to FIG. 3, or edge device 502. However, in other aspects, node 704 may be another type of wireless communications device, and network entity 702 may be another type of network entity or network node, such as those described herein. Note that any operations or signaling illustrated with dashed lines may indicate that that operation or signaling is an optional or alternative example.

Method 700 is described with regard to a set of nodes 704. However, it should be understood that operations described as being performed by the node (including transmission operations, reception operations, and identification operations) may be performed by each node 704 of the set of nodes 704.

Method 700 provides for non-coherent over the air (OTA) computation using multiple receive antennas of the network entity 702, which may improve performance of the physical layer for training AI models in federated learning. For example, the techniques for non-coherent OTA computation using multiple receive antennas of the network entity 702 may reduce the time to converge on a particular AI model parameter, for example, by the network entity 702 varying the gradient step size in accordance with a voting reliability.

At 706, the network entity 702 may send, to a set of nodes 704, first information associated with federated learning at the set of nodes 704. This first information may include a first model parameter and a first gradient step value. The first model parameter may be associated with an AI model. For example, the first model parameter may be an initial weight, bias, or other configuration parameter of an AI model.

At 708, the network entity 702 may receive, from the set of nodes 704, one or more first gradient indications for the first model parameter. The one or more first gradient indications may be received on a first set of receive antennas of the network entity 702.

At 710, the network entity 702 may send, to the set of nodes 704, second information associated with associated with federated learning. The second information may still be related to the first model parameter associated with the AI model but may also include a second gradient step value for the first model parameter. The second gradient step value may be different from the first gradient step value that was sent with the first information. The second gradient step value may be based on a first voting reliability.

In some example, the first voting reliability may be associated with the first model parameter and may be determined by the network entity 702 based on the one or more first gradient indications from the set of nodes 704 that were received on the first set of receive antennas of the network entity 702. The network entity 702 may determine a voting reliability at operation 712. For example, the network entity 702 may reference a representation of a voting reliability chart 714 when determining the first voting reliability.

As a non-limiting example, the voting reliability chart 714 chart includes plots for a number of receive antennas: plot 716a for one receive antenna, plot 716b for four receive antennas, plot 716c for 16 receive antennas and plot 716d for 64 receive antennas. The x-axis of the voting reliability chart 714 chart indicates the percentage of nodes 704 that are sending ‘1’ as the gradient value. The y-axis of the voting reliability chart 714 chart indicates probability of the network entity 702 correctly deciding whether a particular node 704 sent a ‘1’ as the gradient value.

The first voting reliability may be based on a number of receive antennas in the first set of receive antennas. For example, as shown in the voting reliability chart 714 chart, if the percentage of nodes 704 that are sending ‘1’ as the gradient value is 60%, plot 716b for four receive antennas indicates that the probability of the network entity 702 correctly deciding whether a particular node 704 sent a ‘1’ as the gradient value is approximately 70%. However, if the network entity 702 increases the number of receive antennas to 16 receive antennas, then plot 716c for 16 receive antennas indicates that the probability of the network entity 702 correctly deciding whether a particular node 704 sent a ‘1’ as the gradient value increases to approximately 90%.

Similarly, if the percentage of nodes 704 that are sending ‘1’ as the gradient value is 80%, plot 716d for 64 receive antennas indicates that the probability of the network entity 702 correctly deciding whether a particular node 704 sent a ‘1’ as the gradient value is essentially 100%. If the network entity 702 decreases the number of receive antennas to 16 receive antennas, then plot 716c for 16 receive antennas indicates that the probability of the network entity 702 correctly deciding whether a particular node 704 sent a ‘1’ as the gradient value remains at essentially 100%. Thus, performance of the physical layer for training AI models in federated learning may be improved in this example by reducing the power associated with the 38 receive antennas nor longer receiving signal without realizing any degradation in the performance of the training AI model training and operations.

In some examples, the gradient step value may be greater than the first gradient step value. For example, if the first voting reliability satisfies a first threshold (e.g., 80% of the nodes 704 decided ‘1’). Then the network entity 702 on average will observe 80% of its receive antennas detected decision ‘1’, while 20% detected ‘0’. In such an example, the voting reliability can be considered as high, and the gradient step size can be scaled up.

By contrast, the second gradient step value may be less than the first gradient step value, in some examples. For example, if the first voting reliability satisfies a second threshold (e.g., 55% of the nodes 704 decided ‘1’). Then the network entity 702 on average will observe 55% of its receive antennas detected decision ‘1’, while 45% detected ‘0’. In such an example, the voting reliability can be considered as low, and the gradient step size can be scaled down. Similarly, if the first voting reliability satisfies a third threshold (e.g., 50% of the nodes 704 decided ‘1’), the voting reliability can be considered as low, and the gradient step size can be scaled down such that the AI model parameter is zero forced.

In some examples, the network entity 702 may identify, for the first set of receive antennas, a first energy sum (e.g. z₀) of accumulated energies associated with a first time and frequency resource, which may be configured to receive all of the signals from the set of nodes 704 representing the gradient value of ‘0’ from all of the nodes 704 that decided on ‘0’ as the gradient value. The network entity may also identify, for the first set of receive antennas, a second energy sum (e.g. z₁) of accumulated energies associated with the second time and frequency resource, which may be configured to receive all of the signals from the set of nodes 704 representing the gradient value of ‘1’ from all of the nodes 704 that decided on ‘1’ as the gradient value.

The network entity 702 may then transmit, to the set of nodes 704, a first gradient decision for the first model parameter. The first gradient decision may be based on a comparison of the second energy sum and the first energy sum (e.g., network entity 702 decides on ‘1’ if z₁>Z₀ and ‘0’ otherwise).

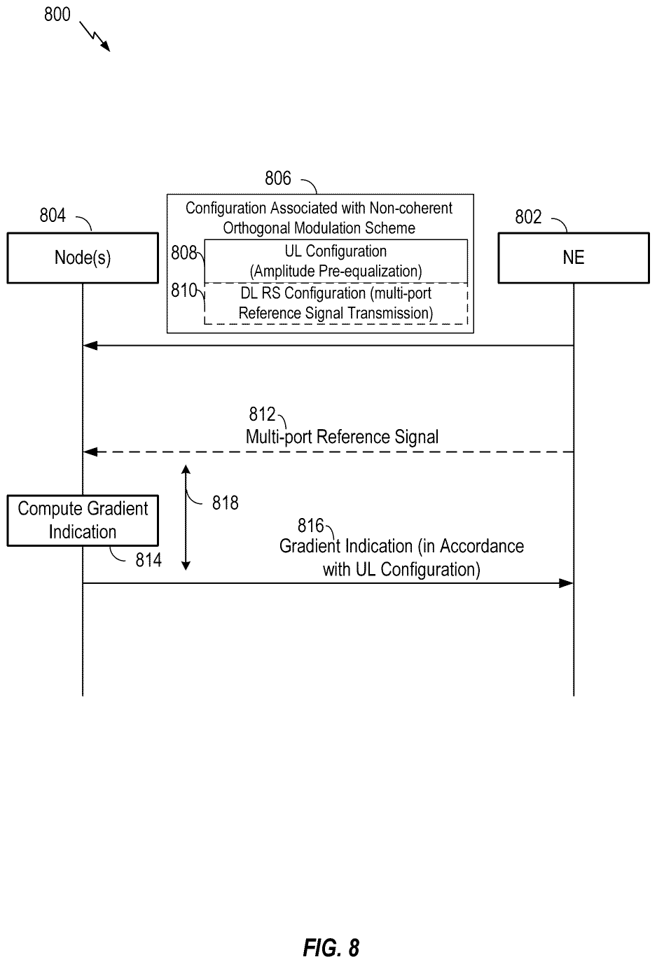

FIG. 8 depicts an example 800 of signaling relating to AI pilot transmission. Example 800 shows signaling communications in a network between a network entity 802 and a node 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Additionally, or alternatively, the network entity 802 may be an example of a parameter server 512. The node 804 may be an example of UE 104 depicted and described with respect to FIG. 1, the UE 304 depicted and described with respect to FIG. 3, or edge device 502. However, in other aspects, node 804 may be another type of wireless communications device and network entity 802 may be another type of network entity or network node, such as those described herein. Note that any operations or signaling illustrated with dashed lines may indicate that that operation or signaling is an optional or alternative example.

Example 800 is described with regard to a single node 804 for clarity. However, it should be understood that operations described as being performed by the node (including transmission operations, reception operations, and identification operations) may be performed by each of a set of nodes that include the node 804.

Example 800 provides for amplitude pre-equalization to be performed by nodes 804 transmitting gradient indications, which is beneficial to equalize signal power (e.g., without phase) for the nodes 804. For example, example 800 provides for amplitude pre-compensation to account for different path losses from one node 804 to another node 804.

As shown at 806, the network entity 802 may transmit, and the node 804 may receive, a configuration associated with a non-coherent orthogonal modulation scheme. The configuration may be associated with the non-coherent orthogonal modulation scheme in that the configuration indicates an amplitude pre-equalization to be used for transmission of signals (e.g., gradient indications) in a non-coherent orthogonal fashion. The configuration may be associated with federated learning at the node 804. For example, the configuration may indicate the amplitude pre-equalization for transmission of gradient indications, or may include a downlink reference signal configuration for a downlink reference signal (e.g., AI pilot) used to determine the amplitude pre-equalization. In some aspects, the non-coherent orthogonal modulation scheme may be associated with federated learning at the node 804. For example, the non-coherent orthogonal modulation scheme may be used for transmission of gradient indications determined as part of the federated learning.

As shown at 808, the configuration may include an uplink configuration. The uplink configuration may indicate an amplitude pre-equalization to be applied by the node 804 for uplink transmissions associated with gradient indications. For example, the amplitude pre-equalization may indicate an adjustment to an amplitude for transmission of a gradient indication. As another example, the amplitude pre-equalization may indicate the amplitude for transmission of the gradient indication. In some aspects, the amplitude pre-equalization is specific to the node 804. For example, the node 804 may feedback information regarding channel conditions at the node 804, which the network entity 802 may use to determine the amplitude pre-equalization. As another example, the network entity 802 may determine the amplitude pre-equalization based on reciprocity with the node 804 (e.g., based on an uplink transmission from the node 804).

In some aspects, the node 804 may determine or adjust the amplitude pre-equalization, for example, based on a downlink reference signal shown at 812. This is described in more detail below.

As shown at 810, the configuration may include a downlink reference signal (RS) configuration. For example, the downlink RS configuration may configure a multi-port reference signal transmission (referred to herein as an AI pilot, since the multi-port reference signal transmission may be used to identify an amplitude pre-equalization for transmission of a gradient indication in connection with AI training). A multi-port reference signal is a reference signal that is transmitted from multiple different antenna ports. Thus, the node 804 can determine channel conditions for other transmissions or receptions on the multiple different antenna ports. In some examples, the multi-port reference signal may be configured with one port per gNB receive antenna (e.g., per receive antenna at the network entity 802) that is to receive a gradient indication from the node 804.

In some aspects, the downlink RS configuration indicates resources for the downlink RS. For example, the downlink RS configuration may indicate a frequency domain density for the downlink RS (e.g., a frequency spacing of occurrences of the downlink RS). In some aspects, the resources for the downlink RS may be multiplexed in the frequency domain (e.g., frequency multiplexed). As another example, the downlink RS configuration may indicate a time resource for the downlink RS. This time resource may be temporally proximate to transmission of a gradient indication, as described below. In some aspects, the downlink RS configuration is common to all nodes 804 associated with a federated learning.

In some aspects, the frequency domain density is based on a channel frequency selectivity. A frequency-selective channel is a channel in which transmissions at different frequencies experience different performance. For example, in a frequency-selective channel, a transmission on a first subcarrier may experience different channel conditions (and thus may arrive at a receiver with a lower amplitude) than a transmission on a second subcarrier at a different frequency than the first subcarrier. In some aspects, the frequency domain density is based on the channel frequency selectivity in that the frequency domain is defined based on a worst-case channel frequency selectivity (such as according to a node 804 experiencing a most frequency-selective channel of all nodes 804 associated with the federated learning or receiving the downlink RS configuration). Thus, the downlink RS can be used to identify relative performance of different frequencies (e.g., subcarriers), thereby enabling the node 804 to pre-equalize (in the amplitude domain) at the different frequencies according to the relative performance. For example, if the downlink RS is received at a strength of “X dB” on a first subcarrier and “X-3 dB” on a second subcarrier, the node 804 may determine an amplitude pre-equalization such that a gradient indication transmission on the first subcarrier and a gradient indication transmitted on the second subcarrier are expected to be received, at the network entity 802, at the same strength.

The multi-port reference signal is shown at 812. As shown at 814, the node 804 computes a gradient indication, as described with respect to FIGS. 5-7. As shown at 816, the node 804 transmits the gradient indication in accordance with the configuration at 806. The gradient indication may be transmitted using a non-coherent transmission, as described in more detail elsewhere herein. In some aspects, the node 804 may use an amplitude pre-equalization indicated by the uplink configuration at 808. In some aspects, the node 804 may use an amplitude pre-equalization determined according to the multi-port reference signal that was transmitted at 812. Thus, the multi-port reference signal may be considered similar to a CSI-RS, and may be used by the nodes 804 for amplitude (e.g., amplitude-only) pre-equalization based on a reciprocity assumption between the network entity 802 and the node 804. That is, for example, a channel may be assumed reciprocal because the channel has the same transmission characteristics in both the UL and DL directions.

As shown, the multi-port reference signal is transmitted (and measured by the node 804) prior to transmission of the gradient indication at 816. For example, the multi-port reference signal may be sent prior to any “OTA aggregation” transmission. As shown by 818, the multi-port reference signal may be temporally proximate to, and prior to (e.g., occurring earlier than), the transmission of the gradient indication. For example, the multi-port reference signal may be sent sufficiently close (in time) to the gradient indication to ensure satisfactory amplitude pre-equalization. In some aspects, a length of time indicated by 818, between the multi-port reference signal and the transmission of the gradient indication, may be based on a channel condition. For example, the multi-port reference signal may be configured within a length of time in which the channel is expected to change by less than a threshold for transmission of the gradient indication. This may be considered “temporally proximate.”

The network entity 802 may perform one or more operations based on the gradient indication. For example, the network entity 802 may perform any one or more operations (or any combination of operations) described with respect to FIGS. 5-7, such as averaging the gradient indication across nodes 804, receiving the gradient indication using a plurality of receive antennas, updating a model parameter, signaling the updated model parameter to the node 804 (and a plurality of nodes associated with the federated learning), or the like.

Note that the process flows illustrated in FIGS. 7 and 8 are described herein to facilitate an understanding of physical layer configurations (e.g., optimizations) techniques used in federated learning, and aspects of the present disclosure may be performed in various manners via alternative or additional signaling and/or operations. In certain aspects, the operations and/or signaling of in FIGS. 7 and 8 may occur in an order different from that described or depicted, and various actions, operations, and/or signaling may be added, omitted, or combined.

### Example Operations of a Network Entity

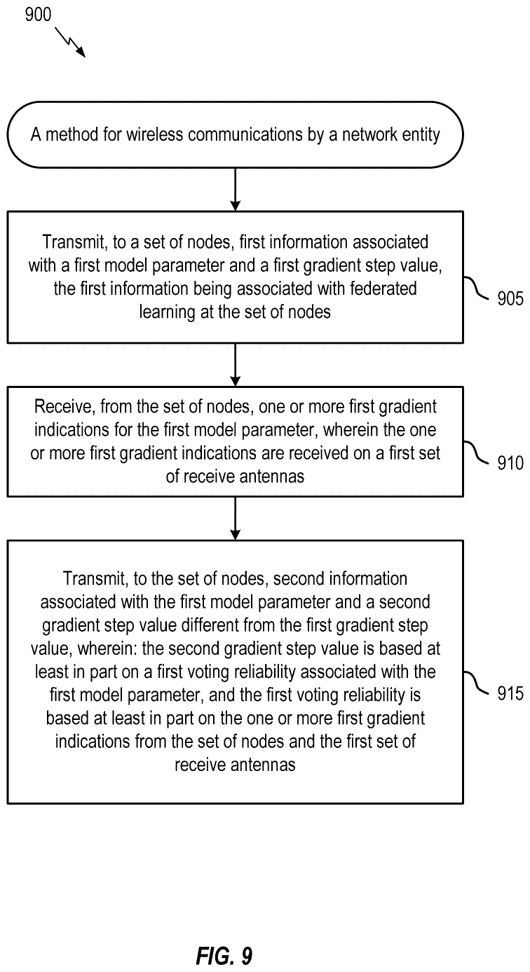

FIG. 9 shows a method 900 for wireless communications by a network entity, such as BS 102 of FIG. 1, a first network entity 300 or second network entity 302 of FIG. 3, or a disaggregated base station as discussed with respect to FIG. 2.

Method 900 begins at block 905 with transmitting, to a set of nodes, first information associated with a first model parameter and a first gradient step value, the first information being associated with federated learning at the set of nodes.

Method 900 then proceeds to block 910 with receiving, from the set of nodes, one or more first gradient indications for the first model parameter, wherein the one or more first gradient indications are received on a first set of receive antennas.

Method 900 then proceeds to block 915 with transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.

In some aspects, the first voting reliability is based at least in part on a number of receive antennas in the first set of receive antennas.

In some aspects, the second gradient step value is greater than the first gradient step value the based at least in part on the first voting reliability satisfying a first threshold.

In some aspects, the second gradient step value is less than the first gradient step value the based at least in part on the first voting reliability satisfying a second threshold.

In some aspects, the first model parameter is zero forced based at least in part on the first voting reliability satisfying a third threshold.

In certain aspects, method 900 further includes identifying, for each receive antenna of the first set of receive antennas, a corresponding first gradient value or second gradient value for each first gradient indication of the one or more first gradient indications.

In certain aspects, method 900 further includes estimating a number of nodes of the set of nodes that indicated the second gradient value for the one or more first gradient indications, wherein the first voting reliability is based at least in part on the number of nodes.

In certain aspects, method 900 further includes transmitting, to the set of nodes, a configuration associated with a non-coherent orthogonal modulation scheme, the configuration indicating a first time and frequency resource and a second time and frequency resource, wherein: the first time and frequency resource is associated with a first gradient value for the one or more first gradient indications, and the second time and frequency resource is associated with a second gradient value different from the first gradient value for the one or more first gradient indications.

In certain aspects, method 900 further includes identifying, for the first set of receive antennas, a first energy sum of accumulated energies associated with the first time and frequency resource.

In certain aspects, method 900 further includes identifying, for the first set of receive antennas, a second energy sum of accumulated energies associated with the second time and frequency resource.

In certain aspects, method 900 further includes transmitting, to the set of nodes, a first gradient decision for the first model parameter, wherein the first gradient decision is based at least in part on a comparison of the second energy sum and the first energy sum.

In certain aspects, method 900 further includes transmitting, to the set of nodes, third information associated with a second model parameter different from the first model parameter, wherein the first model parameter and the second model parameter are associated with a same federated learning model.

In certain aspects, method 900 further includes receiving, from the set of nodes, one or more second gradient indications for the second model parameter, wherein: the one or more second gradient indications are received on a second set of receive antennas different from the first set of receive antennas, and the second set of receive antennas is based at least in part on a second voting reliability associated with the second model parameter.

In some aspects, at least one of the first information or the second information is transmitted via RRC signaling, MAC CE signaling, SI signaling, DCI signaling, or any combination thereof.

In certain aspects, method 900 further includes transmitting, to one or more nodes of the set of nodes, a configuration associated with a non-coherent orthogonal modulation scheme, the configuration comprising an uplink configuration indicating an amplitude pre-equalization to be applied by the one or more nodes for uplink transmissions associated with the one or more first gradient indications.

In some aspects, the configuration comprises a downlink reference signal configuration, the downlink reference signal configuration indicating a multi-port reference signal transmission.

In some aspects, the downlink reference signal configuration is frequency multiplexed and has a density in the frequency domain based at least in part on a frequency selectivity of a channel associated with one or more nodes of the set of nodes.

In certain aspects, method 900 further includes transmitting, to the set of nodes, a downlink reference signal temporally proximate and prior to a time for the set of nodes to respond to one or more rounds of a plurality of rounds of the federated learning, wherein the one or more first gradient indications for the first model parameter correspond to a first round of the one or more rounds of the plurality of rounds.

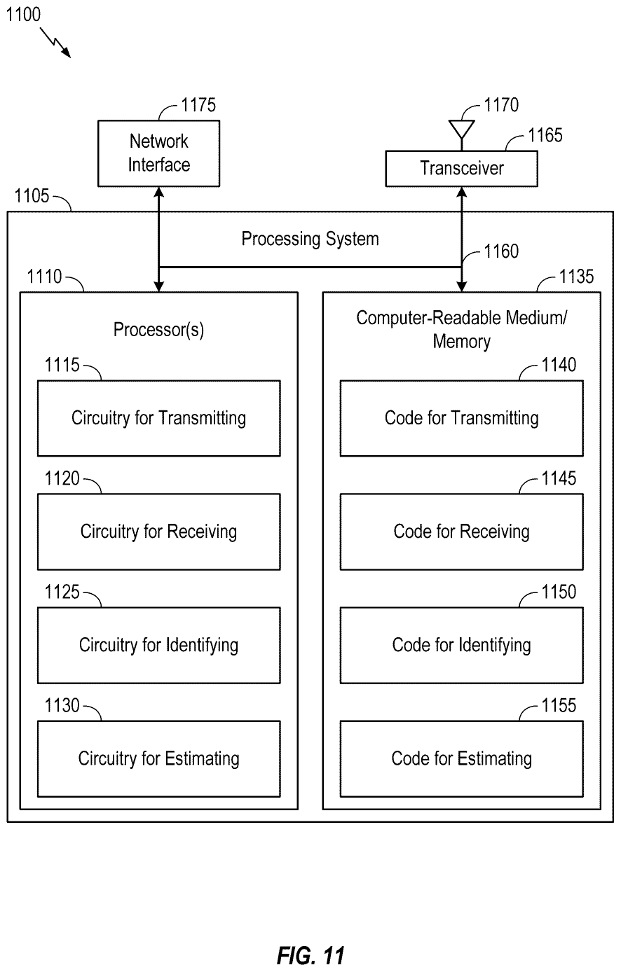

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a User Equipment

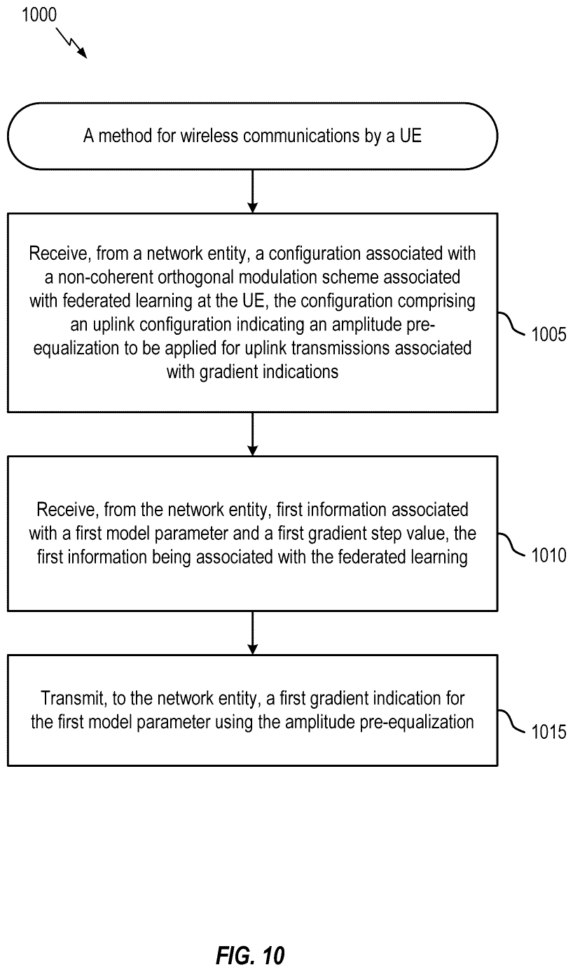

FIG. 10 shows a method 1000 for wireless communications by a UE, such as UE 104 of FIG. 1 or UE 304 of FIG. 3.

Method 1000 begins at block 1005 with receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications.

Method 1000 then proceeds to block 1010 with receiving, from the network entity, first information associated with a first model parameter and a first gradient step value, the first information being associated with the federated learning.

Method 1000 then proceeds to block 1015 with transmitting, to the network entity, a first gradient indication for the first model parameter using the amplitude pre-equalization.

In some aspects, method 1000 further includes receiving, from the network entity, second information associated with the first model parameter and a second gradient step value different from the first gradient step value.

In some aspects, method 1000 further includes receiving, from the network entity, a configuration associated with the non-coherent orthogonal modulation scheme, the configuration indicating a first time and frequency resource and a second time and frequency resource, wherein: the first time and frequency resource is associated with a first gradient value for the first gradient indication, and the second time and frequency resource is associated with a second gradient value different from the first gradient value for the first gradient indication.

In some aspects, the first gradient indication for the first model parameter is transmitted to the first time and frequency resource or the second time and frequency resource, and the first gradient indication is based at least in part on a direction of a local value of the UE that is associated with the first model parameter.

In some aspects, method 1000 further includes receiving, from the network entity, a first gradient decision for the first model parameter.

In some aspects, method 1000 further includes updating a federated learning model associated with the first model parameter based at least in part on the first gradient decision.

In some aspects, method 1000 further includes receiving, from the network entity, third information associated with a second model parameter different from the first model parameter, wherein the first model parameter and the second model parameter are associated with a same federated learning model.

In some aspects, method 1000 further includes transmitting, to the network entity, a second gradient indication for the second model parameter.

In some aspects, at least one of the configuration or the first information is received via RRC signaling, MAC CE signaling, SI signaling, DCI signaling, or any combination thereof.

In some aspects, the configuration comprises a downlink reference signal configuration, the downlink reference signal configuration indicating a multi-port reference signal transmission.

In some aspects, method 1000 further includes receiving, from the network entity, a downlink reference signal temporally proximate and prior to a time for the UE to respond to one or more rounds of a plurality of rounds of the federated learning, wherein the first gradient indication for the first model parameter correspond to a first round of the one or more rounds of the plurality of rounds.

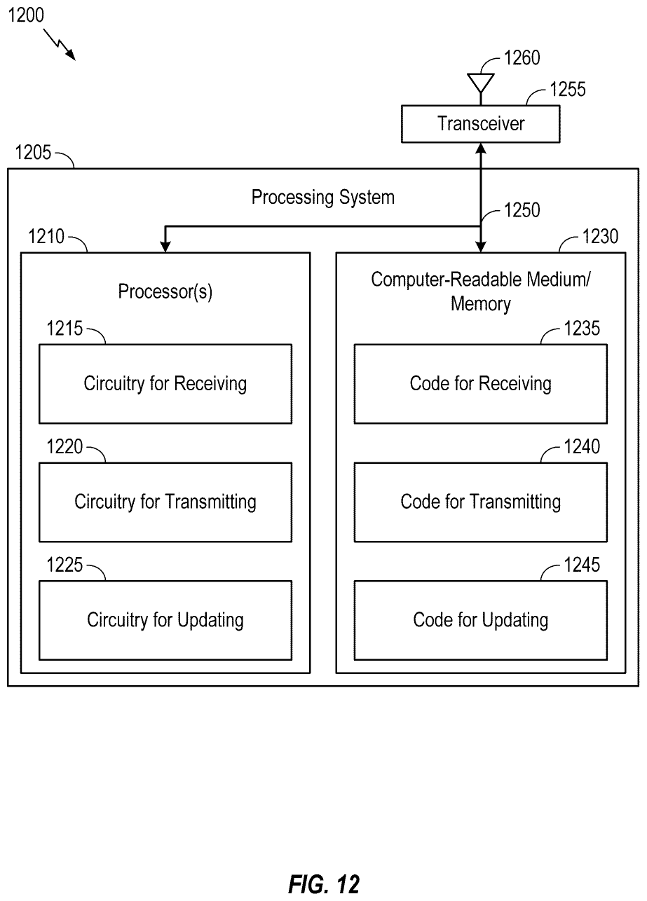

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1165 (e.g., a transmitter and/or a receiver) and/or a network interface 1175. The transceiver 1165 is configured to transmit and receive signals for the communications device 1100 via an antenna 1170, such as the various signals as described herein. The network interface 1175 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1135. In various aspects, one or more processors 1110 may be representative of the one or more processors 308, as described with respect to FIG. 3. The one or more processors 1110 are coupled to the computer-readable medium/memory 1135 via a bus 1160. In certain aspects, the computer-readable medium/memory 1135 is configured to store instructions (e.g., computer-executable code), including code 1140-1155, that when executed by the one or more processors 1110, cause the one or more processors 1110 to perform the method 900 described with respect to FIG. 9, or any aspect related to it, including any operations described in relation to FIG. 9. The computer-readable medium/memory 1135 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1135 stores code (e.g., executable instructions), including code for transmitting 1140, code for receiving 1145, code for identifying 1150, and code for estimating 1155. Processing of the code 1140-1155 may enable and cause the communications device 1100 to perform the method 900 described with respect to FIG. 9, or any aspect related to it. For example, in some aspects, code for transmitting 1140 includes code for transmitting, to a set of nodes, first information associated with a first model parameter and a first gradient step value, the first information being associated with federated learning at the set of nodes. In some aspects, code for receiving 1145 includes code for receiving, from the set of nodes, one or more first gradient indications for the first model parameter, wherein the one or more first gradient indications are received on a first set of receive antennas. In some aspects, code for transmitting 1140 includes code for transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.

The one or more processors 1110 include circuitry configured to implement (e.g., execute) the code stored in the computer-readable medium/memory 1135, including circuitry for transmitting 1115, circuitry for receiving 1120, circuitry for identifying 1125, and circuitry for estimating 1130. Processing with circuitry 1115-1130 may enable and cause the communications device 1100 to perform the method 900 described with respect to FIG. 9, or any aspect related to it. For example, in some aspects, circuitry for transmitting 1115 includes circuitry for transmitting, to a set of nodes, first information associated with a first model parameter and a first gradient step value, the first information being associated with federated learning at the set of nodes. In some aspects, circuitry for receiving 1120 includes circuitry for receiving, from the set of nodes, one or more first gradient indications for the first model parameter, wherein the one or more first gradient indications are received on a first set of receive antennas. In some aspects, circuitry for transmitting 1115 includes circuitry for transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1165, antenna 1170, and/or network interface 1175 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1165, antenna 1170, and/or network interface 1175 of the communications device 1100 in FIG. 11, and/or one or more processors 1110 of the communications device 1100 in FIG. 11. For example, means for identifying or means for estimating of the method 900 described with respect to FIG. 9, or any aspect related to it, may include the one or more transceivers 312, one or more antennas 314, and/or processing system 306 of the first network entity 300 or the second network entity 302 illustrated in FIG. 3, transceiver 1165, antenna 1170, and/or network interface 1175 of the communications device 1100 in FIG. 11, and/or one or more processors 1110 of the communications device 1100 in FIG. 11.

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for receiving 1235, code for transmitting 1240, and code for updating 1245. Processing of the code 1235-1245 may enable and cause the communications device 1200 to perform the method 1000 described with respect to FIG. 10, or any aspect related to it. For example, in some aspects, code for receiving 1235 includes code for receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications. In some aspects, code for receiving 1235 includes code for receiving, from the network entity, first information associated with a first model parameter and a first gradient step value, the first information being associated with the federated learning. In some aspects, code for transmitting 1240 includes code for transmitting, to the network entity, a first gradient indication for the first model parameter using the amplitude pre-equalization.

The one or more processors 1210 include circuitry configured to implement (e.g., execute) the code stored in the computer-readable medium/memory 1230, including circuitry for receiving 1215, circuitry for transmitting 1220, and circuitry for updating 1225. Processing with circuitry 1215-1225 may enable and cause the communications device 1200 to perform the method 1000 described with respect to FIG. 10, or any aspect related to it. For example, in some aspects, circuitry for receiving 1215 includes circuitry for receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications. In some aspects, circuitry for receiving 1215 includes circuitry for receiving, from the network entity, first information associated with a first model parameter and a first gradient step value, the first information being associated with the federated learning. In some aspects, circuitry for transmitting 1220 includes circuitry for transmitting, to the network entity, a first gradient indication for the first model parameter using the amplitude pre-equalization.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

### Example Clauses

Implementation examples are described in the following numbered clauses:
Clause 1: A method for wireless communications by a network entity comprising: transmitting, to a set of nodes, first information associated with a first model parameter and a first gradient step value, the first information being associated with federated learning at the set of nodes; receiving, from the set of nodes, one or more first gradient indications for the first model parameter, wherein the one or more first gradient indications are received on a first set of receive antennas; and transmitting, to the set of nodes, second information associated with the first model parameter and a second gradient step value different from the first gradient step value, wherein: the second gradient step value is based at least in part on a first voting reliability associated with the first model parameter, and the first voting reliability is based at least in part on the one or more first gradient indications from the set of nodes and the first set of receive antennas.
Clause 2: The method of Clause 1, wherein the first voting reliability is based at least in part on a number of receive antennas in the first set of receive antennas.
Clause 3: The method of any one of Clauses 1 and 2, wherein the second gradient step value is greater than the first gradient step value the based at least in part on the first voting reliability satisfying a first threshold.
Clause 4: The method of any one of Clauses 1-3, wherein the second gradient step value is less than the first gradient step value the based at least in part on the first voting reliability satisfying a second threshold.
Clause 5: The method of any one of Clauses 1-4, wherein the first model parameter is zero forced based at least in part on the first voting reliability satisfying a third threshold.
Clause 6: The method of any one of Clauses 1-5, further comprising: identifying, for each receive antenna of the first set of receive antennas, a corresponding first gradient value or second gradient value for each first gradient indication of the one or more first gradient indications; and estimating a number of nodes of the set of nodes that indicated the second gradient value for the one or more first gradient indications, wherein the first voting reliability is based at least in part on the number of nodes.
Clause 7: The method of any one of Clauses 1-6, further comprising: transmitting, to the set of nodes, a configuration associated with a non-coherent orthogonal modulation scheme, the configuration indicating a first time and frequency resource and a second time and frequency resource, wherein: the first time and frequency resource is associated with a first gradient value for the one or more first gradient indications, and the second time and frequency resource is associated with a second gradient value different from the first gradient value for the one or more first gradient indications.
Clause 8: The method of Clause 7, further comprising: identifying, for the first set of receive antennas, a first energy sum of accumulated energies associated with the first time and frequency resource; identifying, for the first set of receive antennas, a second energy sum of accumulated energies associated with the second time and frequency resource; and transmitting, to the set of nodes, a first gradient decision for the first model parameter, wherein the first gradient decision is based at least in part on a comparison of the second energy sum and the first energy sum.
Clause 9: The method of any one of Clauses 1-8, further comprising: transmitting, to the set of nodes, third information associated with a second model parameter different from the first model parameter, wherein the first model parameter and the second model parameter are associated with a same federated learning model; and receiving, from the set of nodes, one or more second gradient indications for the second model parameter, wherein: the one or more second gradient indications are received on a second set of receive antennas different from the first set of receive antennas, and the second set of receive antennas is based at least in part on a second voting reliability associated with the second model parameter.
Clause 10: The method of any one of Clauses 1-9, wherein at least one of the first information or the second information is transmitted via RRC signaling, MAC CE signaling, SI signaling, DCI signaling, or any combination thereof.
Clause 11: The method of any one of Clauses 1-10, further comprising: transmitting, to one or more nodes of the set of nodes, a configuration associated with a non-coherent orthogonal modulation scheme, the configuration comprising an uplink configuration indicating an amplitude pre-equalization to be applied by the one or more nodes for uplink transmissions associated with the one or more first gradient indications.
Clause 12: The method of Clause 11, wherein the configuration comprises a downlink reference signal configuration, the downlink reference signal configuration indicating a multi-port reference signal transmission.
Clause 13: The method of Clause 12, wherein the downlink reference signal configuration is frequency multiplexed and has a density in the frequency domain based at least in part on a frequency selectivity of a channel associated with one or more nodes of the set of nodes.
Clause 14: The method of any one of Clauses 1-13, further comprising: transmitting, to the set of nodes, a downlink reference signal temporally proximate and prior to a time for the set of nodes to respond to one or more rounds of a plurality of rounds of the federated learning, wherein the one or more first gradient indications for the first model parameter correspond to a first round of the one or more rounds of the plurality of rounds.
Clause 15: A method for wireless communications by a UE comprising: receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications; receiving, from the network entity, first information associated with a first model parameter and a first gradient step value, the first information being associated with the federated learning; and transmitting, to the network entity, a first gradient indication for the first model parameter using the amplitude pre-equalization.
Clause 16: The method of Clause 15, further comprising: receiving, from the network entity, second information associated with the first model parameter and a second gradient step value different from the first gradient step value.
Clause 17: The method of any one of Clauses 15 and 16, further comprising: receiving, from the network entity, a configuration associated with the non-coherent orthogonal modulation scheme, the configuration indicating a first time and frequency resource and a second time and frequency resource, wherein: the first time and frequency resource is associated with a first gradient value for the first gradient indication, and the second time and frequency resource is associated with a second gradient value different from the first gradient value for the first gradient indication.
Clause 18: The method of Clause 17, wherein: the first gradient indication for the first model parameter is transmitted to the first time and frequency resource or the second time and frequency resource, and the first gradient indication is based at least in part on a direction of a local value of the UE that is associated with the first model parameter.
Clause 19: The method of any one of Clauses 15-18, further comprising: receiving, from the network entity, a first gradient decision for the first model parameter; and updating a federated learning model associated with the first model parameter based at least in part on the first gradient decision.
Clause 20: The method of any one of Clauses 15-19, further comprising: receiving, from the network entity, third information associated with a second model parameter different from the first model parameter, wherein the first model parameter and the second model parameter are associated with a same federated learning model; and transmitting, to the network entity, a second gradient indication for the second model parameter.
Clause 21: The method of any one of Clauses 15-20, wherein at least one of the configuration or the first information is received via RRC signaling, MAC CE signaling, SI signaling, DCI signaling, or any combination thereof.
Clause 22: The method of any one of Clauses 15-21, wherein the configuration comprises a downlink reference signal configuration, the downlink reference signal configuration indicating a multi-port reference signal transmission.
Clause 23: The method of any one of Clauses 15-22, further comprising: receiving, from the network entity, a downlink reference signal temporally proximate and prior to a time for the UE to respond to one or more rounds of a plurality of rounds of the federated learning, wherein the first gradient indication for the first model parameter correspond to a first round of the one or more rounds of the plurality of rounds.
Clause 24: One or more apparatuses, comprising: one or more memories comprising executable instructions; and one or more processors configured to execute the executable instructions and cause the one or more apparatuses to perform a method in accordance with any one of Clauses 1-23.
Clause 25: One or more apparatuses configured for wireless communications, comprising: one or more memories; and one or more processors, coupled to the one or more memories, configured to cause the one or more apparatuses to perform a method in accordance with any one of Clauses 1-23.
Clause 26: One or more apparatuses configured for wireless communications, comprising: one or more memories; and one or more processors, coupled to the one or more memories, configured to perform a method in accordance with any one of Clauses 1-23.
Clause 27: One or more apparatuses, comprising means for performing a method in accordance with any one of Clauses 1-23.
Clause 28: One or more non-transitory computer-readable media comprising executable instructions that, when executed by one or more processors of one or more apparatuses, cause the one or more apparatuses to perform a method in accordance with any one of Clauses 1-23.
Clause 29: One or more computer program products embodied on one or more computer-readable storage media comprising code for performing a method in accordance with any one of Clauses 1-23.
Clause 30: One or more apparatuses configured for wireless communications, comprising: a processing system that includes one or more processors and one or more memories coupled with the one or more processors, the processing system configured to cause the one or more apparatuses to perform a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a network entity to:
transmit, to a set of nodes, first information associated with a first model parameter and a first gradient step value, the first information being associated with federated learning at the set of nodes;
receive, from the set of nodes, one or more first gradient indications for the first model parameter, wherein the one or more first gradient indications are received on a first set of receive antennas; and
transmit, to the set of nodes, second information associated with the first model parameter and a second gradient step value different from the first gradient step value, wherein:
the second gradient step value is based at least in part on a first voting reliability associated with the first model parameter, and
the first voting reliability is based at least in part on the one or more first gradient indications from the set of nodes and the first set of receive antennas.

2. The apparatus of claim 1, wherein the first voting reliability is based at least in part on a number of receive antennas in the first set of receive antennas.

3. The apparatus of claim 1, wherein the second gradient step value is greater than the first gradient step value the based at least in part on the first voting reliability satisfying a first threshold.

4. The apparatus of claim 1, wherein the second gradient step value is less than the first gradient step value the based at least in part on the first voting reliability satisfying a second threshold.

5. The apparatus of claim 1, wherein the first model parameter is zero forced based at least in part on the first voting reliability satisfying a third threshold.

6. The apparatus of claim 1, wherein the processing system is configured to cause the network entity to:
identify, for each receive antenna of the first set of receive antennas, a corresponding first gradient value or second gradient value for each first gradient indication of the one or more first gradient indications; and
estimate a number of nodes of the set of nodes that indicated the second gradient value for the one or more first gradient indications, wherein the first voting reliability is based at least in part on the number of nodes.

7. The apparatus of claim 1, wherein the processing system is configured to cause the network entity to:
transmit, to the set of nodes, a configuration associated with a non-coherent orthogonal modulation scheme, the configuration indicating a first time and frequency resource and a second time and frequency resource, wherein:
the first time and frequency resource is associated with a first gradient value for the one or more first gradient indications, and
the second time and frequency resource is associated with a second gradient value different from the first gradient value for the one or more first gradient indications.

8. The apparatus of claim 7, wherein the processing system is configured to cause the network entity to:
identify, for the first set of receive antennas, a first energy sum of accumulated energies associated with the first time and frequency resource;
identify, for the first set of receive antennas, a second energy sum of accumulated energies associated with the second time and frequency resource; and
transmit, to the set of nodes, a first gradient decision for the first model parameter, wherein the first gradient decision is based at least in part on a comparison of the second energy sum and the first energy sum.

9. The apparatus of claim 1, wherein the processing system is configured to cause the network entity to:
transmit, to the set of nodes, third information associated with a second model parameter different from the first model parameter, wherein the first model parameter and the second model parameter are associated with a same federated learning model; and
receive, from the set of nodes, one or more second gradient indications for the second model parameter, wherein:
the one or more second gradient indications are received on a second set of receive antennas different from the first set of receive antennas, and
the second set of receive antennas is based at least in part on a second voting reliability associated with the second model parameter.

10. The apparatus of claim 1, wherein at least one of the first information or the second information is transmitted via radio resource control (RRC) signaling, media access control (MAC) control element (CE) signaling, system information (SI) signaling, downlink control information (DCI) signaling, or any combination thereof.

11. The apparatus of claim 1, wherein the processing system is configured to cause the network entity to:
transmit, to one or more nodes of the set of nodes, a configuration associated with a non-coherent orthogonal modulation scheme, the configuration comprising an uplink configuration indicating an amplitude pre-equalization to be applied by the one or more nodes for uplink transmissions associated with the one or more first gradient indications.

12. The apparatus of claim 11, wherein the configuration comprises a downlink reference signal configuration, the downlink reference signal configuration indicating a multi-port reference signal transmission.

13. The apparatus of claim 12, wherein the downlink reference signal configuration is frequency multiplexed and has a density in the frequency domain based at least in part on a frequency selectivity of a channel associated with one or more nodes of the set of nodes.

14. The apparatus of claim 1, wherein the processing system is configured to cause the network entity to:
transmit, to the set of nodes, a downlink reference signal temporally proximate and prior to a time for the set of nodes to respond to one or more rounds of a plurality of rounds of the federated learning, wherein the one or more first gradient indications for the first model parameter correspond to a first round of the one or more rounds of the plurality of rounds.

15. An apparatus for wireless communications, comprising a processing system that includes one or more processors and one or more memories coupled with the one or more processors, the processing system configured to cause a user equipment (UE) to:
receive, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications;
receive, from the network entity, first information associated with a first model parameter and a first gradient step value, the first information being associated with the federated learning; and
transmit, to the network entity, a first gradient indication for the first model parameter using the amplitude pre-equalization.

16. The apparatus of claim 15, wherein the processing system is configured to cause the UE to:
receive, from the network entity, second information associated with the first model parameter and a second gradient step value different from the first gradient step value.

17. The apparatus of claim 15, wherein the processing system is configured to cause the UE to:
receive, from the network entity, a configuration associated with the non-coherent orthogonal modulation scheme, the configuration indicating a first time and frequency resource and a second time and frequency resource, wherein:
the first time and frequency resource is associated with a first gradient value for the first gradient indication, and
the second time and frequency resource is associated with a second gradient value different from the first gradient value for the first gradient indication.

18. The apparatus of claim 17, wherein:
the first gradient indication for the first model parameter is transmitted to the first time and frequency resource or the second time and frequency resource, and
the first gradient indication is based at least in part on a direction of a local value of the UE that is associated with the first model parameter.

19. The apparatus of claim 15, wherein the processing system is configured to cause the UE to:
receive, from the network entity, a first gradient decision for the first model parameter; and
update a federated learning model associated with the first model parameter based at least in part on the first gradient decision.

20. The apparatus of claim 15, wherein the processing system is configured to cause the UE to:
receive, from the network entity, third information associated with a second model parameter different from the first model parameter, wherein the first model parameter and the second model parameter are associated with a same federated learning model; and
transmit, to the network entity, a second gradient indication for the second model parameter.

21. The apparatus of claim 15, wherein at least one of the configuration or the first information is received via radio resource control (RRC) signaling, media access control (MAC) control element (CE) signaling, system information (SI) signaling, downlink control information (DCI) signaling, or any combination thereof.

22. The apparatus of claim 15, wherein the configuration comprises a downlink reference signal configuration, the downlink reference signal configuration indicating a multi-port reference signal transmission.

23. The apparatus of claim 15, wherein the processing system is configured to cause the UE to:
receive, from the network entity, a downlink reference signal temporally proximate and prior to a time for the UE to respond to one or more rounds of a plurality of rounds of the federated learning, wherein the first gradient indication for the first model parameter correspond to a first round of the one or more rounds of the plurality of rounds.

24. A method for wireless communications by a network entity, the method comprising:
transmitting, to a set of nodes, first information associated with a first model parameter and a first gradient step value, the first information being associated with federated learning at the set of nodes;
receiving, from the set of nodes, one or more first gradient indications for the first model parameter, wherein the one or more first gradient indications are received on a first set of receive antennas; and
transmitting, to the set of nodes, second information associated with the first model parameter and a second gradient step value different from the first gradient step value, wherein:
the second gradient step value is based at least in part on a first voting reliability associated with the first model parameter, and
the first voting reliability is based at least in part on the one or more first gradient indications from the set of nodes and the first set of receive antennas.

25. The method of claim 24, wherein the first voting reliability is based at least in part on a number of receive antennas in the first set of receive antennas.

26. The method of claim 24, wherein the second gradient step value is greater than the first gradient step value the based at least in part on the first voting reliability satisfying a first threshold.

27. The method of claim 24, wherein the second gradient step value is less than the first gradient step value the based at least in part on the first voting reliability satisfying a second threshold.

28. The method of claim 24, wherein the first model parameter is zero forced based at least in part on the first voting reliability satisfying a third threshold.

29. A method for wireless communications by a user equipment (UE), the method comprising:
receiving, from a network entity, a configuration associated with a non-coherent orthogonal modulation scheme associated with federated learning at the UE, the configuration comprising an uplink configuration indicating an amplitude pre-equalization to be applied for uplink transmissions associated with gradient indications;
receiving, from the network entity, first information associated with a first model parameter and a first gradient step value, the first information being associated with the federated learning; and
transmitting, to the network entity, a first gradient indication for the first model parameter using the amplitude pre-equalization.

30. The method of claim 29, further comprising:
receiving, from the network entity, second information associated with the first model parameter and a second gradient step value different from the first gradient step value.
